(19) United States
(12) Patent Application Publication
(10) Pub. No.: US 2017/0301301 A1
(43) Pub. Date: Oct. 19, 2017

(54) DISPLAY SYSTEMS AND METHODS FOR PROVIDING BLACK FRAME INSERTION THEREOF

(71) Applicant: MediaTek Inc., Hsin-Chu (TW)

(72) Inventors: Ting-Jian PAN, Zhubei City (TW); Cheng-Che CHEN, New Taipei City (TW); Yan-Shao LIU, Hsinchu City (TW); Hao-Ting HUANG, Hsinchu City (TW)

(21) Appl. No.: 15/130,991

(22) Filed: Apr. 17, 2016

(51) Int. Cl. G09G 3/36; G06T 5/00

(52) U.S. Cl. CPC G09G 3/3618; G09G 3/3607; G06T 5/003; G09G 2330/021; G09G 2310/08; G09G 2310/0245; G09G 2340/0435; G09G 2340/16; G09G 2320/0261

(57) ABSTRACT

Methods for providing black frame insertion in a display system are provided, wherein the display system includes a display device, a driving module coupled to the display device and a processor coupled to the driving module. First, a control signal is generated and sent to the driving module by the processor to control the driving module to perform black frame insertion in a black frame insertion period. A control signal is generated by the processor and sent to the driving module to control the driving module to perform the black frame insertion in the black frame insertion period. Inserted image data for use in the black frame insertion is generated by the driving module to be displayed by the display device during the black frame insertion period in response to receiving the control signal.

### BACKGROUND OF THE INVENTION

### Field of the Invention

The invention relates to image processing techniques, and more precisely, to methods and systems for providing black frame insertion capable of reducing power consumption of a driving end.

### Description of the Related Art

In order to solve the problem of a motion blur occurs in the liquid crystal display (LCD) when displaying dynamic images, a method of black frame insertion (BFI) is utilized. Black frame insertion is a motion picture technology in which a black frame data may be inserted after every picture data frame to eliminate the motion blur. It generally requires twice frame rate to renew the frames for using the black frame insertion technology to display the images in the prior art, that is, a scanning frequency is changed from 60 Hz into 120 Hz. That is to say, image voltages are provided for pixels in a frame period, and a black grayscale voltage (i.e. black frame) is provided for the pixels in another frame period.

Existing black frame insertion (e.g., 120 Hz black frame insertion) may insert a black or gray screen through every 1/60 second, to promote the overall drive to 120 Hz. However, a driving end needs to increase the frame rate sent from 60 Hz to 120 Hz, thereby increase the driving end of bandwidth with power consumption.

Thus, a method and system for providing black frame insertion to reduce power consumption of the driving end to reduce LCD motion blur is called for.

### BRIEF SUMMARY OF THE INVENTION

In a first aspect of the invention, a method for providing black frame insertion in a display system is provided, wherein the display system comprises a display device, a driving module coupled to the display device and a processor coupled to the driving module. The method includes the following steps. First, a control signal is generated by the processor and sent to the driving module to control the driving module to perform black frame insertion in a black frame insertion period. A control signal is generated by the processor and sent to the driving module to control the driving module to perform the black frame insertion in the black frame insertion period. Inserted image data for use in the black frame insertion is then generated by the driving module to be displayed by the display device during the black frame insertion period in response to receiving the control signal.

In a second aspect of the invention, a display system is provided. The display system comprises a display device, a driving module and a processor. The driving module is coupled to the display device for controlling the operation of the display device. The processor is coupled to the driving module for generating a control signal and sending the control signal to the driving module to control the driving module to perform black frame insertion in a black frame insertion period, such that the driving module, in response to receiving the control signal, generates inserted image data for use in the black frame insertion to be displayed by the display device during the black frame insertion period.

In a third aspect of the invention, a method for providing black frame insertion executed by a processor is provided. The processor couples to a driving module for driving a display device. The method comprises the steps of: determining a frame period for outputting normal image data and a black frame insertion period for performing a black frame insertion according to a refresh rate of the display device; and generating a control signal and sending the control signal to the driving module to control the driving module to perform the black frame insertion in the black frame insertion period.

Other aspects and features of the present invention will become apparent to those with ordinary skill in the art upon review of the following descriptions of specific embodiments of and the display systems and devices for carrying out the method for providing black frame insertion.

### BRIEF DESCRIPTION OF THE DRAWINGS

The invention can be more fully understood by reading the subsequent detailed description and examples with reference to the accompanying drawings, wherein:

FIG. 1 is a block diagram illustrating the functional units of a display system according to an embodiment of the invention;

FIG. 2 shows a flow chart of the method for providing black frame insertion according to an embodiment of the invention;

FIG. 3 is a schematic diagram illustrating a command format according to an embodiment of the invention;

FIG. 4 is a timing diagram illustrating a timing sequence of black frame insertion operation according to an embodiment of the invention;

FIG. 5 shows a flow chart of the method for providing black frame insertion according to another embodiment of the invention;

FIG. 6 shows a flow chart of the method for providing black frame insertion according to another embodiment of the invention; and

FIG. 7 shows a flow chart of the method for providing black frame insertion according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

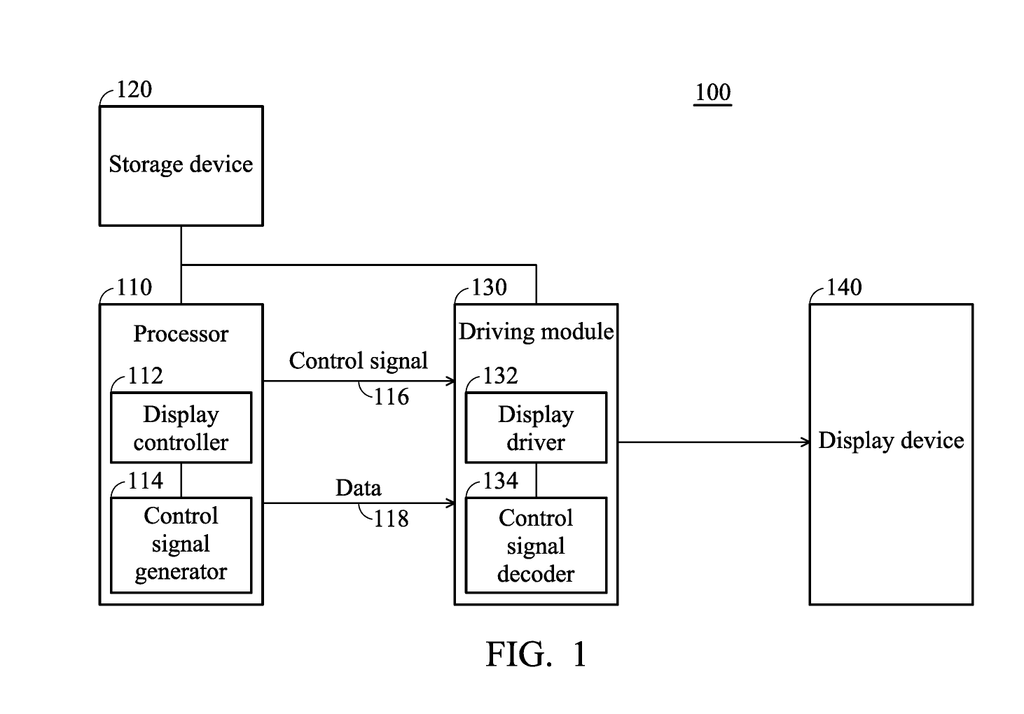

The invention is now described with reference to FIGS. 1 through 7, which generally relate to providing black frame insertion. In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the invention. The following detailed description is, therefore, not to be taken in a limiting sense. It should be understood that many of the elements described and illustrated throughout the specification are functional in nature and may be embodied in one or more physical entities or may take other forms beyond those described or depicted.

FIG. 1 is a block diagram illustrating the functional units of a display system 100 according to an embodiment of the invention. The display system 100 may include a processor 110, a storage device 120, a driving module 130 and a display device 140, wherein the storage device 120 is coupled to the processor 110, the driving module 130 is coupled to the processor 110 and the storage device 120, and the display device 140 is coupled to the driving module 130. The driving module 130 is configured to control operation of the display device 140 (e.g. a LCD). For example, in one embodiment, the display system 100 can be a LCD system and the driving module 130 is a LCD driving module with a LCD driver and the display device is a LCD panel, but the invention is not limited thereto. On the other hand, the processor 110 may be a Central Processing Unit (CPU), Micro-Control Unit (MCU), Digital Signal Processor (DSP), a graphics processing unit (GPU), a general purpose processor or a special purpose processor or the like, which provides the function of data processing and computing.

The storage device 120 may be a non-volatile storage medium (e.g., Read-Only Memory (ROM), Flash memory, magnetic tape, hard disk, or optical disc), or a volatile storage medium (e.g., Random Access Memory (RAM)), or any combination thereof for storing data, such as instructions, program codes, image data. More particularly, the memory 120 may include a series of instructions and/or program codes which when executed (e.g. by the processor 110 and/or the driving module 130) causes the processor 110 and/or the driving module 130 to perform the method for providing black frame insertion of embodiments of the invention. In some embodiments, the method includes generating a control signal and sending the control signal by the processor 110 to the driving module 130 to control the driving module 130 to perform the black frame insertion in the black frame insertion period. The method may further include generating inserted image data for use in the black frame insertion by the driving module 130 to be displayed by the display device 140 during the black frame insertion period in response to receiving the control signal.

The processor 110 may further comprise a display controller 112 and a control signal generator 114. The display controller 112 is arranged for generating display data to be displayed by the display device 140. The control signal generator 114 may generate a specific command signal to control the driving module 130 to perform a black frame insertion operation by itself. To be more specific, the processor 110 can control the display controller 112 and the control signal generator 114 to perform the method for providing black frame insertion of embodiments of the invention. The processor 110 may receive image data and send the image data to the driving module 130 directly via the display controller 112 if the frame rate of a source image data is the same as the refresh rate of the display device 140. Conversely, the processor 110 may receive image data and send the image data via a data link 118 through the display controller 112 and further generate one or more control signals to the driving module 130 via a connection link 116 through the control signal generator 114 such that the driving module 130 outputs or generates one or more black frame data to be displayed by the display device 140 if the frame rate of the source image is not the same as the refresh rate of the display device 140. The data link 118 may be one or more physical links capable of transmitting the image data between the processor 110 and the driving module 130. Similarly, the connection link 116 may be the same or different one or more physical links capable of transmitting the control signal between the processor 110 and the driving module 130. For example, the processor 110 may receive image data and send the image data to the driving module 130 via the data link 118 in a frame period and generate one or more control signals to the driving module 130 via the connection link 116 through the display controller 112 and the control signal generator 114 in another frame period such that the driving module 130 outputs or generates one or more black frame data to be displayed by the display device 140 to renew the frames for using the black frame insertion technology to display the images if the frame rate of the source image is 60 fps and the refresh rate of the display device 140 is 120 fps.

The driving module 130 may further comprise a display driver 132 and a control signal decoder 134, wherein the control signal decoder 134 can decode control signals for example in form of commands received from the processor 110 and perform respective operation according to the decoded command. For example, the display driver 132 may determine that a black frame insertion is required and thus perform the black frame insertion according to a decoding result of the command.

The display driver 132 is used for generating driving signals to drive the display device 140 for displaying. For example, the display driver 132 can be a LCD driver which can generate related driving signals to drive the LCD to display data. For example, the storage device 120 may store an image to be displayed on the display device 140.

The display device 140, for example, may be a LCD or an Electronic Paper Display (EPD), for providing the display function, and the invention is not limited thereto. In some embodiments, the display device 140 may further be integrated with a touch-sensitive device (not shown). The touch-sensitive device comprises a touch-sensitive surface comprising sensors in at least one dimension to detect contact and/or movement of at least one object (input tool), such as a pen/stylus or finger near or on the touch-sensitive surface.

Although not shown, the display system 100 may further comprise other functional units, such as a wireless communication unit, an Input/Output (I/O) device, e.g., button, keyboard, or mouse, etc., and the invention is not limited thereto. The wireless communication unit is responsible for providing the function of wired or wireless network access, so that the display system 100 may connect to the Internet or a particular server set up on the Internet. The wired network access may include an Ethernet connection, an Asymmetric Digital Subscriber Line (ADSL), a cable connection, or the like. The wireless network access may include a connection to a Wireless Local Area Network (WLAN), a WCDMA system, a Code Division Multiple Access 2000 (CDMA-2000) net system work, a Time Division-Synchronous Code Division Multiple Access (TD-SCDMA) system, a Worldwide Interoperability for Microwave Access (WiMAX) system, a Long Term Evolution (LTE) system, an LTE Advanced (LTE-A) system, or a Time-Division LTE (TD-LTE) system. The wireless communication unit may comprise a Radio Frequency (RF) unit and a Baseband unit. Specifically, the Baseband unit may contain multiple hardware devices to perform baseband signal processing, including ADC/DAC, gain adjusting, modulation/demodulation, encoding/decoding, and so on, while the RF unit may receive RF wireless signals, convert the received RF wireless signals to baseband signals, which are processed by the Baseband unit, or receive baseband signals from the baseband unit and convert the received baseband signals to RF wireless signals, which are transmitted later. The RF unit may also contain multiple hardware devices to perform radio frequency conversion, such as a mixer for multiplying the baseband signals with a carrier oscillated in the radio frequency of the wireless communications system, wherein the radio frequency may be 2.4 GHz or 5 GHz utilized in the Wireless-Fidelity (WiFi) technology, or may be 2.402-2.480 GHz utilized in the Bluetooth technology, or others depending on the wireless technology in use.

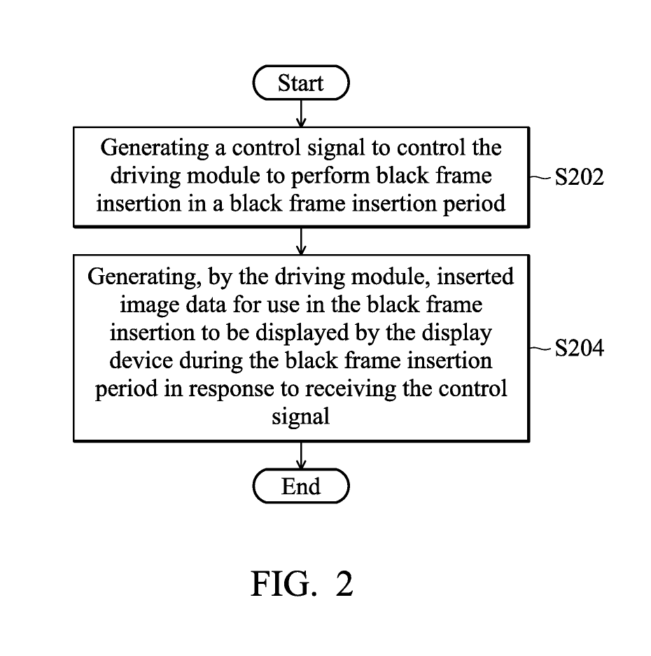

FIG. 2 shows a flow chart of the method for providing black frame insertion according to an embodiment of the invention. In this embodiment, the method can be applied to the display system 100 as shown in FIG. 1 and performed by the processor 110 and the driving module 130 of the display system 100. The application is for purpose of explanation and the invention is not limited thereto. Periods when normal image data are output to the display device 140 for displaying are referred to as frame periods, and periods when gray or black image data are output to the display device 140 for displaying are referred to as black frame insertion periods, which will be descried further in the following paragraphs with reference to FIG. 4 as an example.

First, when in the black frame insertion period, i.e., an image data is to be inserted, in step S202, a control signal is generated by the processor 110 to control the driving module 130 to perform a black frame insertion and can be sent via the connection link 116 to the driving module 130. The control signal can be an enabling signal or a command signal. In some embodiment, the enabling signal can be a general purpose input/output (GPIO) signal.

In some embodiments, a frame period for outputting normal image data or frame data and a black frame insertion period for performing a black frame insertion can be determined by the processor 110. The determination can be made according to a refresh rate of the display device 140 driven by the driving module 130. For example, the processor 110 may determine the black frame insertion period is next to each frame period if the frame rate of the image data is 60 fps and the refresh rate of the display device 140 is 120 fps.

In some embodiments, the frame period for outputting normal image data or frame data and the black frame insertion period for performing a black frame insertion can also be determined by the driving module 130 according to the refresh rate of the display device 140.

In response to receiving the control signal via the connection link 116, in step S204, the driving module 130 generates inserted image data for use in the black frame insertion to be displayed by the display device 140 during the black frame insertion period so as to generate image data which matches the refresh rate of the display device 140.

To be more specific, the processor 110 may output first image data in a first frame rate (e.g., a frame rate of 60 fps) to the driver module 130, and the driving module 130 may output second image data in a second frame rate (e.g., a frame rate of 120 fps). To achieve this, the driving module 130 can additionally insert image data in a third frame rate (e.g., a frame rate of 60 fps) into the first image data in response to the control signal. In this way, the second image data can include the inserted image data and then the driving module 130 can output the second image data in the second frame rate higher than the first frame rate. Accordingly, the second image data generated by the driving module 130 matches the refresh rate of the display device 140. In other words, the driving module 130 can perform the black frame insertion by itself in each black frame insertion period by simply responding to the control signal sent by the processor 110.

The steps S202 and S204 can be repeated to generate image data with a dedicated frame rate (e.g., 120 Hz). For example, the driving module 130 can insert image data for one black frame insertion period or a predetermined number of black frame insertion periods into the first image data in response to a control signal. Alternatively, the steps S202 and S204 can be performed once to generate image data with a dedicated frame rate. For example, the driving module 130 can insert image data for plural black frame insertion periods into the first image data in response to a control signal and stop/change the inserting after receiving another control signal indicating a different frame rate or the original frame rate.

In some embodiments, the control signal may be generated as a specific command signal and sent from the processor 110 to the driving module 130. To be more specific, the processor 110 can generate a specific command signal through the control signal generator 110 to serve as the control signal for controlling or enabling the driving module 130 to perform a black frame insertion. In some embodiments, the command signal may comprise one or more data fields for controlling the driving module 130 to perform the black frame insertion according to one or more data values in the one or more data fields. When receiving the specific command signal from the processor 110, the driving module 130 decodes the specific command signal received through the control signal decoder 134 and performs the black frame insertion operation by itself to output one or more black frame data to the display device 140 according to one or more data values in the one or more data fields.

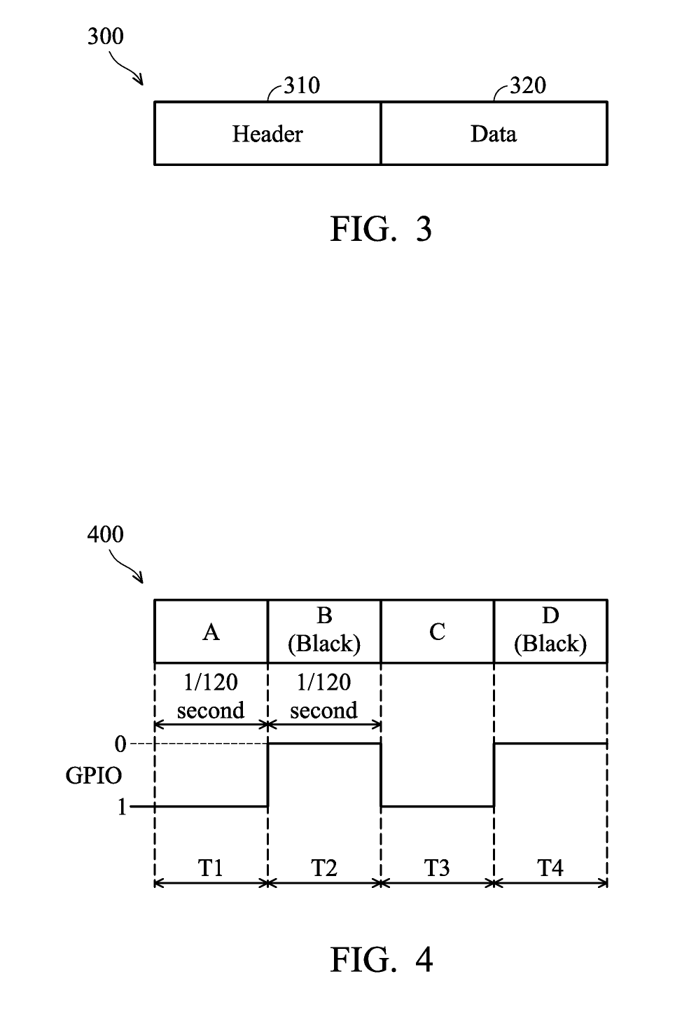

FIG. 3 is a schematic diagram illustrating a command format of the specific command signal according to an embodiment of the invention. As shown in FIG. 3, the specific command signal 300 comprises at least one or more fields. For example, the fields may include either or both of a Header field 310 and a Data field 320. The Header field 310 may be used for indicating whether a black frame or a gray frame is to be inserted. The Data field 320 may be used for indicating the number of the black frame or the gray frame to be inserted during the black frame insertion operation. For example, the command 300 can be a first command indicating that a black frame or a black image data is to be inserted when its Header field 310 is with a value of “AAH” and the command 300 can be a second command indicating that a gray frame or a gray image data is to be inserted when its Header field 310 is with a value of “ABH”.

Additionally or alternatively, the Data field 310 or another field of the command 300 may findicate information about either or both a cycle period of the black frame insertion and the black frame insertion period. For example, the command signal 300 may indicate that a black frame is to be inserted when each frame data is sent or it may indicate that a black frame is to be inserted when two frame data are sent, for example, through the data value in the Data field 310 of the specific command signal 300. In other embodiments, the command signal 300 may also indicate that two or more black frames are to be inserted when two frame data are sent or it may indicate that two black frames are to be inserted when three or more frame data are sent, for example.

In some embodiments, the processor 110 may further comprise one or more general purpose input/output (GPIO) pins and the processor 110 can generate a GPIO signal via one of the GPIO pins as the control signal. The driving module 130 may further comprise a GPIO pin connected to the GPIO pin of the processor 110. The GPIO signal which is generated by a GPIO pin may be used as an enabling signal to enable or control the driving module 130 to perform a black frame insertion by itself. The driving module 130 can determine whether to perform the black frame insertion according to the GPIO signal. To be more specific, the driving module 130 determines to perform the black frame insertion when the GPIO signal received is at a first level (e.g., at a high level) and determines not to perform the black frame insertion when the GPIO signal received is not at the first level (e.g., at a low level). For example, the GPIO signal can be at a low level or a high level. For example, in one embodiment, when the GPIO signal is at a low level, the black frame insertion is not being performed and when the GPIO signal is at a high level, the black frame insertion is being performed by the driving module 130. In another embodiment, when the GPIO signal is at a high level, the black frame insertion is not being performed and when the GPIO signal is at a low level, the black frame insertion is being performed by the driving module 130. The driving module 130 may perform the black frame insertion by outputting a black frame image to be displayed by the display device 140 so as to refresh a black screen on the display device 140.

In some embodiments, the driving module 130 may perform the black frame insertion by outputting a gray or black frame image to be displayed by the display device 140 so as to refresh a black screen on the display device 140. To be more specific, the processor 110 may output first image data in a first frame rate (e.g., a frame rate of 60 fps) to the driver module 130, and the driving module 130 may output second image data in a second frame rate (e.g., a frame rate of 120 fps). To achieve this, the second image data can include the inserted image data and therefore the second frame rate can be higher than the first frame rate, allowing the driving module 130 to generate an image data which matches the refresh rate of the display device 140. In other words, the driving module 130 performs the black frame insertion by itself in each black frame insertion period. In one embodiment, the processor 110 may send the GPIO signal to the driving module 310 every black frame insertion period.

In some implementations, different types of control signals can be sent. In one embodiment, the processor 110 may send the GPIO signal together with other type(s) of control signal(s), which for example, may indicate information about either or both a cycle period of the black frame insertion and the black frame insertion period (e.g., a command signal) to the driving module 310 to control the driving module 130 to generate black image data or gray image data as the inserted image data for use in the black frame insertion and perform the black frame insertion according to the cycle period of the black frame insertion.

FIG. 4 is a timing diagram illustrating a timing sequence 400 of black frame insertion operation according to an embodiment of the invention. As shown in FIG. 4, in the timing sequence 400, assuming that data includes images A, B, C and D are to be displayed in sequence. The images B and D are black images, wherein the image A, the black image (i.e., the image B), the image C and the black image (i.e., the image D) are sequentially output to the display device 140 for displaying. Periods when the images A and C are output to the display device 140 for displaying (e.g., time periods T1 and T3) are referred to as frame periods, and periods when the images B and D are output to the display device 140 for displaying (e.g., time periods T2 and T4) are referred to as black frame insertion periods. The frame period and the black frame insertion period have the same time length, which is, for example, 1/120 second. The black frame insertion period may be configured between one or more frame periods. In some embodiments, the frame period and the black frame insertion period are next to each other. In some embodiments, the black frame insertion period is configured between two or more frame periods. For example, in one embodiment, the image A, the image C and the black image (i.e., the image B) are sequentially output to the driving module 130 (e.g., a LCD driving module) for displaying.

As shown in FIG. 4, the GPIO signal generated by the GPIO pin of the processor 110 are at a high level (i.e., “1”) in the time periods T2 and T4 and at a low level (i.e., “0”) in the time periods T1 and T3. The driving module 130 determines to perform the black frame insertion to generate the images B and D in the time periods T2 and T4 (i.e., the black frame insertion periods) since the GPIO signal is at a high level. Notably, the embodiment is explained with a GPIO signal serving as a control signal but the disclosure is not limited thereto.

It should also be noted that conventionally, the images B and D are generated by a driving end (i.e., the processor 110) while in the present embodiment, the images B and D are generated by the driving module 130 according to the signal level of the GPIO signal.

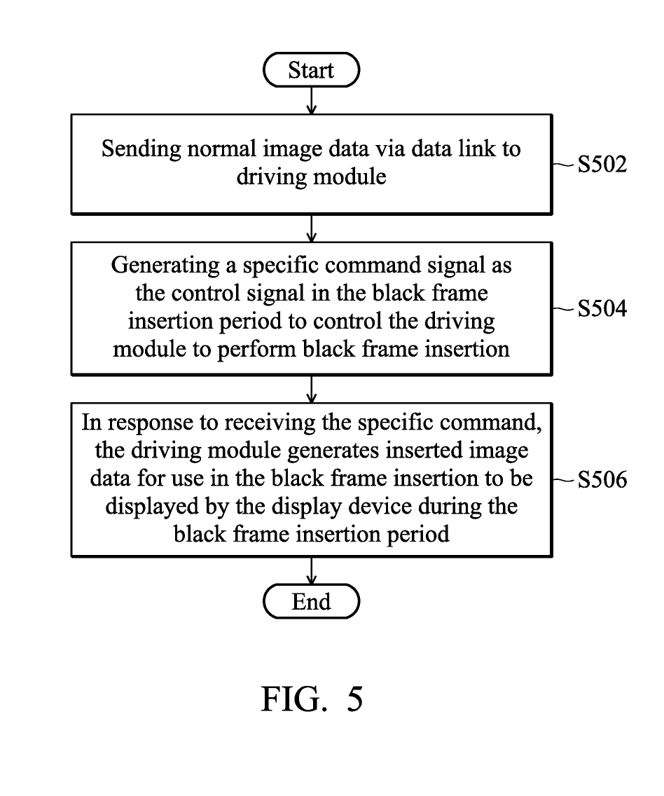

FIG. 5 shows a flow chart of the method for providing black frame insertion according to another embodiment of the invention. The method can be applied to the display system 100 as shown in FIG. 1 and performed by the processor 110 and the driving module 130 of the display system 100 but is not limited thereto. The steps of the flow chart can be performed separately or combinedly in different implementations. Alternatively or additionally, the steps of the flow chart may be performed in an order different from that shown in FIG. 5. In this embodiment, it is assumed that the frame periods and the black insertion periods have been determined by the processor 110 or the driving module 130.

First, in step S502, normal image data or frame data is sent by the processor 110 via the data link 118 to the driving module 130 in each frame period.

After the frame period, in each black frame insertion period, in step S504, a specific command signal (e.g., the command signal 300 of FIG. 3) is generated by the processor 110 as the control signal to control the driving module 130 to perform black frame insertion. For example, the specific command signal can be a first command signal indicating that a black frame or a black image data is to be inserted or it can be a second command signal indicating that a gray frame or a gray image data is to be inserted during the black frame insertion.

In response to receiving the specific command signal, in each black frame insertion period, in step S506, the driving module 130 generates inserted image data for use in the black frame insertion to be displayed by the display device 140 during the black frame insertion period. As mentioned for step S504, the specific command signal may further indicate whether the driving module 130 should generate black image data or gray image data as the inserted image data for use in the black frame insertion. So in step S506, the driving module 130 can responsively generate black image data or gray image data as the inserted image data for use in the black frame insertion according to the specific command signal. For example, the driving module 130 may perform the black frame insertion by outputting black image data when the specific command signal is the first command signal or it may perform the black frame insertion by outputting gray image data when the specific command signal is the second command signal.

Similarly, the steps S504 and S506 may be repeated to generate image data with a dedicated frame rate (e.g., 120 Hz, 150 Hz, 180 Hz . . . ). It is noted that in other embodiments, the specific command signal may not be sent each black frame insertion period, which means that in response to receiving the control signal in one frame period, multiple black frame insertion periods can be generated respectively after multiple black frame periods. For example, in step S504, the specific command signal may further indicate information about either or both a cycle period of the black frame insertion and the black frame insertion period, and in step S506 the driving module 130 may further perform the black frame insertion in the back frame insertion period every cycle period of the back frame insertion.

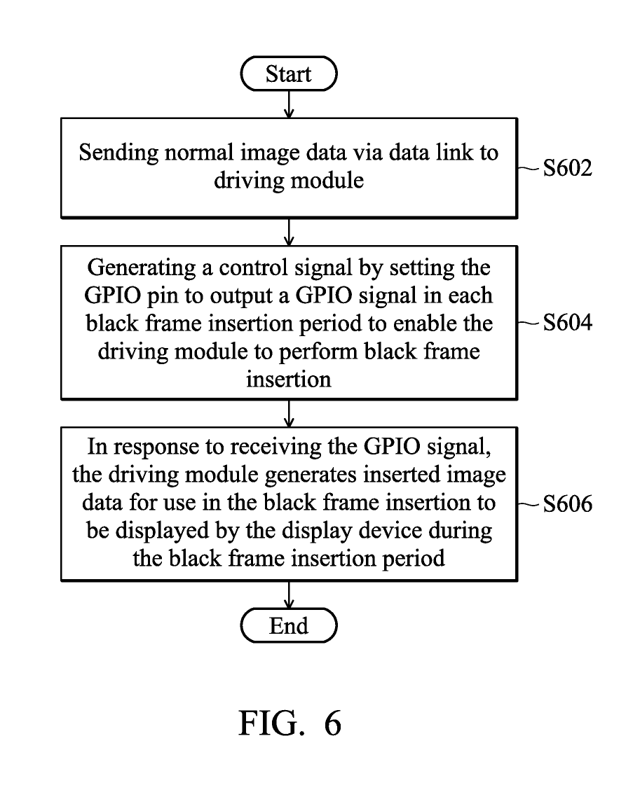

FIG. 6 shows a flow chart of the method for providing black frame insertion according to another embodiment of the invention. The method can be applied to the display system 100 as shown in FIG. 1 and performed by the processor 110 and the driving module 130 of the display system 100 but is not limited thereto. In this embodiment, it is assumed that the frame periods and the black insertion periods have been determined by the processor 110. It is also assumed that a GPIO pin of the driving module 130 is connected to the GPIO pin of the processor 110, which forms the connection link 116, wherein the GPIO pin of the driving module 130 and the GPIO pin of the processor 110 are assumed at a low level at initial and switched to a specific level, e.g., a high level, to enable black frame insertion. For example, the driving module 130 may determine to perform the black frame insertion when the GPIO signal is at the high level and determine not to perform the black frame insertion when the GPIO signal is at the low level.

First, in step S602, normal image data or frame data is sent by the processor 110 via the data link 118 to the driving module 130 in each frame period. The GPIO pin can be kept in the low level in each frame period, which causes the driving module 130 not to perform the back frame insertion.

After the frame period, in each black frame insertion period, in step S604, the GPIO pin is set by the processor 110 to output a GPIO signal with the high level as the control signal to control or enable the driving module 130 to perform black frame insertion. In response to receiving the high level of the GPIO signal, in each black frame insertion period, in step S606, the driving module 130 generates inserted image data for use in the black frame insertion to be displayed by the display device 140 during the black frame insertion period. Additionally, the driving module 130 may perform the black frame insertion by outputting a gray or black frame image to be displayed by the display device 140 so as to refresh a black screen on the display device 140. To be more specific, the driving module 130 may perform the black frame insertion by outputting black image data when the specific command signal is the first command or it may perform the black frame insertion by outputting gray image data when the specific command signal is the second command signal.

In the embodiment of FIG. 6, the steps S604 and S606 can be repeated to generate image data with a dedicated frame rate (e.g., 120 Hz, 150 Hz, 180 Hz . . . ). It is noted that in other embodiments, the specific command signal may not be sent each black frame insertion period, which means that in response to receiving the control signal in one frame period, multiple black frame insertion periods can be generated respectively after multiple black frame periods.

It is noted that in the embodiment of FIG. 6, the processor 110 may send the GPIO signal to the driving module 310 every black frame insertion period. However, in other embodiments, the processor 110 may send the GPIO signal together with one or more other control signals. For example, the processor 110 may send the GPIO signal together with another control signal (e.g., a command signal) which indicates information about either or both a cycle period of the black frame insertion and the black frame insertion period to the driving module 310 to control the driving module 130 to generate black image data or gray image data as the inserted image data for use in the black frame insertion and perform the black frame insertion according to the cycle period of the black frame insertion.

For example, in one embodiment, the driving module 130 may output/insert a black image data after each frame data is sent when a cycle period of the black frame insertion is set to be 1 or it may output/insert a black image data after two frame data are sent when the cycle period of the black frame insertion is set to be 2. In another embodiment, the driving module 130 may output/insert a black image data after each frame data is sent when the cycle period of the black frame insertion is set to be 1 or it may output/insert two black image data after every two frame data are sent when the cycle period of the black frame insertion is set to be 2.

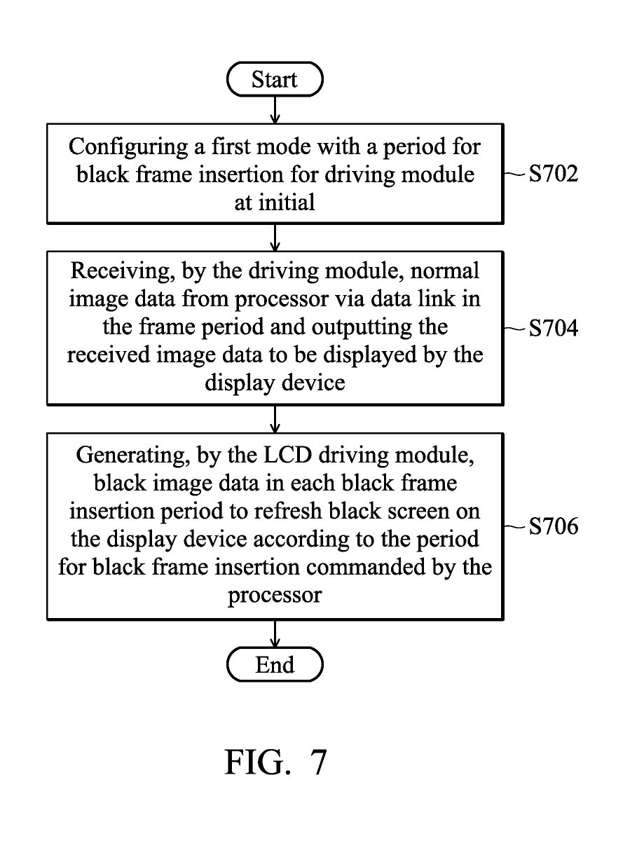

In some embodiments, the control signal may further control the driving module 130 to change to a specific mode (referred to as a first mode herein) where the driving module 130 automatically performs the black frame insertion in every back frame insertion period after entering the first mode. FIG. 7 shows a flow chart of the method for providing black frame insertion according to another embodiment of the invention. The method can be applied to the display system 100 as shown in FIG. 1 and performed by the processor 110 and the driving module 130 of the display system 100.

First, in step S702, a first mode is configured for the driving module 130 by the processor 110 at initial stage. In this step, the processor 110 may send a control signal to control the driving module 130 to change to a first mode where the driving module 130 automatically performs the black frame insertion in every back frame insertion period after entering the first mode. For example, the processor 110 may send a command signal as the control signal.

In step S702, a period for black frame insertion can also be configured for use in the first mode. The period for black frame insertion means a number of frame periods a black image data should be inserted after. For example, the period for black frame insertion may indicate that a black frame should be inserted after every two frame periods. In other words, the driving module automatically outputs a black frame to the display device 140 after every two images data. To achieve this, the command signal may further indicate information about the period for the black frame insertion to control the driving module 130 to change to the first mode. In another embodiment, another control signal indicating the period may also be sent in addition to the command signal.

Then, in each frame period, in step S704, normal image data or frame data is sent by the processor 110 via the data link 118 to the driving module 130 and thus the driving module 130 receives normal image data or frame data from the processor 110 and outputs the received data to be displayed by the display device 140.

After the frame period, in each black frame insertion period, in step S706, the driving module 130 periodically generates black image data in each black frame insertion period to refresh black screen on the display device since it operating in the first mode. As mentioned, the driving module 130 can generate black image data according to the period for black frame insertion commanded by the processor 110. It is noted that the processor 110 can further generate another control signal for controlling the driving module 130 to switch back to a normal mode or a second mode corresponding to the original frame rate or a different frame rate. For example, the period for black frame insertion may indicate that a black frame should be inserted after every two frame periods and thus the driving module 130 automatically outputs a black frame to the display device 140 after every two images data are output to the display device 140.

Similarly, in some embodiments, the driving module 130 may further determine either or both a cycle time of the black frame insertion and the black frame insertion period, and the driving module 130 further performs the black frame insertion in the back frame insertion period every cycle time of the back frame insertion. For example, the driving module 130 may output/insert a black image data after every two frame data are received when the period for the black frame insertion or the cycle time of the black frame insertion is set to be 2.

Similarly, in some embodiments, the control signal further indicates information about either or both a cycle period of the black frame insertion and the black frame insertion period, and the driving module 130 further performs the black frame insertion in the back frame insertion period every cycle period of the back frame insertion. For example, the cycle period for black frame insertion may indicate that two or more black frames should be inserted after every two or more frame periods and thus the driving module 130 automatically outputs two or more black frames to the display device 140 after every two or more images data are output to the display device 140.

In summary, according to the display systems and related method for providing black frame insertion of the embodiments of the invention, an additional signal is provided from the driving end to the driving module to control the driving module to automatically refresh black or gray screen by itself when a black frame insertion is needed without requiring the driving end to send black or gray screen, which allows the driving end to maintain its frame rate and increases the refresh rate of the driving module, thereby greatly reducing the power consumption and bandwidth requirement of the driving end and providing a power-efficient black frame insertion.

The embodiments of methods for providing black frame insertion that have been described, or certain aspects or portions thereof, may be practiced in logic circuits, or may take the form of program code (i.e., instructions) embodied in tangible media, such as floppy diskettes, CD-ROMS, hard drives, or any other machine-readable storage medium, wherein, when the program codes are loaded into and executed by a machine, such as a smartphone, a mobile phone, or a similar device, the machine becomes an apparatus for practicing the invention. The disclosed methods may also be embodied in the form of program codes transmitted over some transmission medium, such as electrical wiring or cabling, through fiber optics, or via any other form of transmission, wherein, when the program codes are received and loaded into and executed by a machine, the machine becomes an apparatus for practicing the invention. When implemented on a general-purpose processor, the program codes combine with the processor to provide a unique apparatus that operate analogously to specific logic circuits.

Use of ordinal terms such as “first” and “second” in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of preferred embodiment, it is to be understood that the invention is not limited thereto. On the contrary, it is intended to cover various modifications and similar arrangements (as would be apparent to the skilled in the art). Therefore, the scope of the appended claims should be accorded the broadest interpretation so as to encompass all such modifications and similar arrangements.

What is claimed is:

1. A method for providing black frame insertion in a display system, wherein the display system comprises a display device, a driving module coupled to the display device and a processor coupled to the driving module, the method comprising:
generating, by the processor, a control signal and sending the control signal to the driving module to control the driving module to perform black frame insertion in a black frame insertion period; and
generating, by the driving module, inserted image data for use in the black frame insertion to be displayed by the display device during the black frame insertion period in response to receiving the control signal.

2. The method of claim 1, further comprising outputting, by the processor, first image data in a first frame rate to the driver module, and outputting, by the driving module, second image data in a second frame rate, the second image data including the inserted image data and the second frame rate higher than the first frame rate.

3. The method of claim 1, further comprising determining, by the processor, a frame period for outputting normal image data and a black frame insertion period for performing a black frame insertion according to a refresh rate of the display device.

4. The method of claim 1, further comprising: determining, by the driving module, a frame period for outputting normal image data and a black frame insertion period for performing a black frame insertion according to a refresh rate of the display device.

5. The method of claim 1, wherein the control signal comprises an enabling signal.

6. The method of claim 5, wherein the enabling signal is a general purpose input/output (GPIO) signal.

7. The method of claim 6, further comprising: determining, by the driving module, to perform the black frame insertion when the GPIO signal is at a first level and determines not to perform the black frame insertion when the GPIO signal is not at the first level.

8. The method of claim 1, wherein the control signal comprises a command signal.

9. The method of claim 8, wherein the command signal comprises one or more data fields for controlling the driving module to perform the black frame insertion according to one or more data values in the one or more data fields.

10. The method of claim 1, wherein the driving module generates black image data as the inserted image data for use in the black frame insertion.

11. The method of claim 1, wherein, the control signal further indicates whether the driving module generates black image data or gray image data as the inserted image data for use in the black frame insertion.

12. The method of claim 1, wherein the processor further sends the control signal to the driving module every black frame insertion period.

13. The method of claim 1, wherein the control signal further controls the driving module to change to a first mode where the driving module automatically performs the black frame insertion in every back frame insertion period after entering the first mode.

14. The method of claim 13, wherein the control signal further indicates information about either or both a cycle period of the black frame insertion and the black frame insertion period, and the driving module further performs the black frame insertion in the back frame insertion period every cycle period of the back frame insertion.

15. The method of claim 14, further comprising determining, by the driving module, either or both a cycle time of the black frame insertion and the black frame insertion period, and the driving module further performs the black frame insertion in the back frame insertion period every cycle time of the back frame insertion.

16. A display system, comprising:
a driving module coupled to a display device for controlling the operation of the display device; and
a processor coupled to the driving module, generating a control signal and sending the control signal to the driving module to control the driving module to perform black frame insertion in a black frame insertion period,
such that the driving module, in response to receiving the control signal, generates inserted image data for use in the black frame insertion to be displayed by the display device during the black frame insertion period.

17. The display system of claim 16, wherein the processor further outputs first image data in a first frame rate to the driver module, and the driving module further outputs second image data in a second frame rate, the second image data including the inserted image data and the second frame rate higher than the first frame rate.

18. The display system of claim 16, wherein the processor further determines a frame period for outputting normal image data and a black frame insertion period for performing a black frame insertion according to a refresh rate of the display device.

19. The display system of claim 16, wherein the driving module further determines a frame period for outputting normal image data and a black frame insertion period for performing a black frame insertion according to a refresh rate of the display device.

20. The display system of claim 16, wherein the control signal comprises an enabling signal.

21. The display system of claim 20, wherein the enabling signal is a general purpose input/output (GPIO) signal.

22. The display system of claim 21, wherein the driving module further determines to perform the black frame insertion when the GPIO signal is at a first level and determines not to perform the black frame insertion when the GPIO signal is not at the first level.

23. The display system of claim 16, wherein the control signal comprises a command signal.

24. The display system of claim 23, wherein the command signal comprises one or more data fields for controlling the driving module to perform the black frame insertion according to one or more data values in the one or more data fields.

25. The display system of claim 16, wherein the driving module generates black image data as the inserted image data for use in the black frame insertion.

26. The display system of claim 16, wherein, the control signal further indicates whether the driving module generates black image data or gray image data as the inserted image data for use in the black frame insertion.

27. The display system of claim 16, wherein the processor further sends the control signal to the driving module every black frame insertion period.

28. The display system of claim 16, wherein the control signal further controls the driving module to change to a first mode where the driving module automatically performs the black frame insertion in every back frame insertion period after entering the first mode.

29. The display system of claim 28, wherein the control signal further indicates information about either or both a cycle period of the black frame insertion and the black frame insertion period, and the driving module further performs the black frame insertion in the back frame insertion period every cycle period of the back frame insertion.

30. The display system of claim 29, wherein the driver module further determines either or both a cycle time of the black frame insertion and the black frame insertion period, and the driving module further performs the black frame insertion in the back frame insertion period every cycle time of the back frame insertion.

31. The display system of claim 16, wherein the display system is a liquid crystal display (LCD) system, the driving module is a LCD driving module with a LCD driver and the display device is a LCD panel.

32. A method for providing black frame insertion executed by a processor, the processor configured to be coupled to a driving module for driving a display device, the method comprising:
determining a frame period for outputting normal image data and a black frame insertion period for performing a black frame insertion according to a refresh rate of the display device; and
generating a control signal and sending the control signal to the driving module to control the driving module to perform the black frame insertion in the black frame insertion period.

33. The method of claim 32, wherein the processor further generates a general purpose input/output (GPIO) signal as the control signal.

34. The method of claim 32, wherein the processor further generates a command signal as the control signal.

35. The method of claim 34, wherein the command signal comprises one or more data fields for controlling the driving module to perform the black frame insertion according to one or more data values in the one or more data fields.

36. The method of claim 32, wherein the control signal further indicates whether the driving module generates black image data or gray image data as the inserted image data for use in the black frame insertion.

37. The method of claim 32, wherein the processor further sends the control signal to the driving module every black frame insertion period.
